(19) United States
(12) Patent Application Publication
(10) Pub. No.: US 2017/0298817 A1
(43) Pub. Date: Oct. 19, 2017

(54) COMBUSTOR AND GAS TURBINE ENGINE

(71) Applicant: KAWASAKI JUKOGYO KABUSHIKI KAISHA, Hyogo (JP)

(72) Inventors: Takeshi HORIUCHI, Kobe-shi, Hyogo (JP); Atsushi HORIKAWA, Akashi-shi, Hyogo (JP); Seiji YAMASHITA, Kobe-shi, Hyogo (JP); Masahide KAZARI, Akashi-shi, Hyogo (JP); Takeo ODA, Kobe-shi, Hyogo (JP)

(73) Assignee: KAWASAKI JUKOGYO KABUSHIKI KAISHA, Hyogo (JP)

(21) Appl. No.: 15/513,943

(22) PCT Filed: Oct. 7, 2015
(86) PCT No.: PCT/JP2015/078450

§ 371 Date: Mar. 23, 2017

(30) Foreign Application Priority Data
Oct. 10, 2014 (JP) 2014-209221

(51) Int. Cl. F02C 3/22; F23R 3/34; F02C 7/16; F23R 3/36; F02C 3/04; F02C 7/228; F02C 3/30; F23R 3/00

(52) U.S. Cl. CPC F02C 3/22; F02C 3/30; F23R 3/34; F23R 3/002; F23R 3/36; F02C 3/04; F02C 7/228; F02C 7/16; F05D 2240/35; F05D 2220/32

(57) ABSTRACT

Provided is a combustor that has an efficient cooling structure. Also provided is a gas turbine engine that is provided with the combustor. A combustor that is for a gas turbine and that is provided with a combustion liner and with a fuel injection part that is provided to one end of the combustion liner so as to pass through the combustion liner. The combustion liner is provided with an inner liner that forms a combustion chamber inside the combustion liner, with a coolant flow path that is an annular space that is formed outside the inner liner, and with a coolant supply means that supplies hydrogen gas to the coolant flow path. In this combustor, the inner liner that is the combustion chamber is cooled by the hydrogen gas that flows in the coolant flow path.

### TECHNICAL FIELD

The present invention relates to a combustor combusting a fuel and a gas turbine engine including the combustor.

### BACKGROUND

Patent Document 1 discloses a combustor for use with a gas turbine engine for combusting a fuel such as natural gas composed mainly of hydrocarbons. To reduce an amount of generation of nitrogen oxides (NOx), a fuel cylinder surrounding a combustion chamber of this combustor is configured in a double structure made up of an inner liner and an outer liner, and a cooling air is supplied to a cylindrical space formed between the inner liner and the outer liner so as to lower a temperature of flame.

### PRIOR ART DOCUMENT

### Patent Document

Patent Document 1: JP 2011-220250 A

### SUMMARY OF THE INVENTION

### Technical Problem

The combustor for gas turbine engine disclosed in Patent Document 1 uses as the cooling air a portion of compressed air generated by a compressor of the gas turbine engine. Therefore, although called as cooling air, the compressed air has a temperature of about 400 degrees Celsius to about 500 degrees Celsius. Therefore, the compressed cooling air, in spite of the fact that the temperature thereof is relatively lower than that of the combustor (about 1,500 degrees Celsius to about 2,000 degrees Celsius), may not be able to effectively cool the combustor exposed to high temperature.

Then, an object of the present invention is to provide a combustor having an efficient cooling structure, and a gas turbine engine including the combustor.

To achieve this object, a first aspect of the present invention provides a combustor for a gas turbine comprising a combustion liner; and a fuel injector provided at one end of the combustion liner to extend through the combustion liner, and the combustion liner includes an inner liner forming a combustion chamber therein, a coolant flow path in a cylindrical space formed outside the inner liner, and a coolant supplying means for supplying a hydrogen gas to the coolant flow path.

According to a second aspect of the present invention, the coolant flow path is connected to the fuel injector, and a hydrogen gas supplied from the coolant supplying means through the coolant flow path to the fuel injector is injected from the fuel injector into the combustion chamber.

According to a third aspect of the present invention, the fuel injector is connected to a water vapor supply source, and a water vapor supplied from the water vapor supply source and the hydrogen supplied from the hydrogen supply source are mixed in the fuel injector and then injected into the combustion chamber.

According to a fourth aspect of the present invention, the fuel injector is connected to a hydrocarbon fuel supply source, and the hydrocarbon fuel injected from the fuel injector into the combustion chamber is combusted together with the hydrogen and the water vapor in the combustion chamber.

According to a fifth aspect of the present invention, the combustion liner includes at least one supplemental burner, and the supplemental burner has a supplemental fuel supply source. In this case, the supplemental fuel supply source may be a hydrogen supply source. This fifth aspect can be combined with any of the first to fourth aspects.

Any of the combustors of the first to fifth aspects described above can individually be incorporated in a gas turbine engine.

### ADVANTAGEOUS EFFECT OF INVENTION

According to the combustor and the gas turbine engine according to the present invention, the combustion chamber can efficiently be cooled by the hydrogen gas. Additionally, since the hydrogen after absorbing heat is mixed with the water vapor, this water vapor does not turn into a drain. This eliminates the problem of corrosion caused due to a drain adhering to the combustion liner etc.

### BRIEF DESCRIPTION OF DRAWINGS

FIG. 1 is a diagram showing a general construction of a gas turbine engine according to the present invention.

FIG. 2 is a longitudinal sectional view of a combustor mounted in the gas turbine engine of FIG. 1.

FIG. 3 is a longitudinal sectional view of the combustor according to a first embodiment.

FIG. 4 is a partially enlarged view of a tailing tube of the combustor shown in FIG. 3.

FIG. 5 is a longitudinal sectional view of a combustor according to a second embodiment.

FIG. 6 is a longitudinal sectional view of a combustor according to a third embodiment.

FIG. 7 is a longitudinal sectional view of a combustor according to a fourth embodiment.

FIG. 8 is a partially enlarged view of a supplemental burner of the combustor shown in FIG. 7.

### DESCRIPTION OF THE EMBODIMENTS

With reference to the accompanying drawings, several embodiments of a combustor and a gas turbine engine including the combustor, according to the present invention, will now be described.

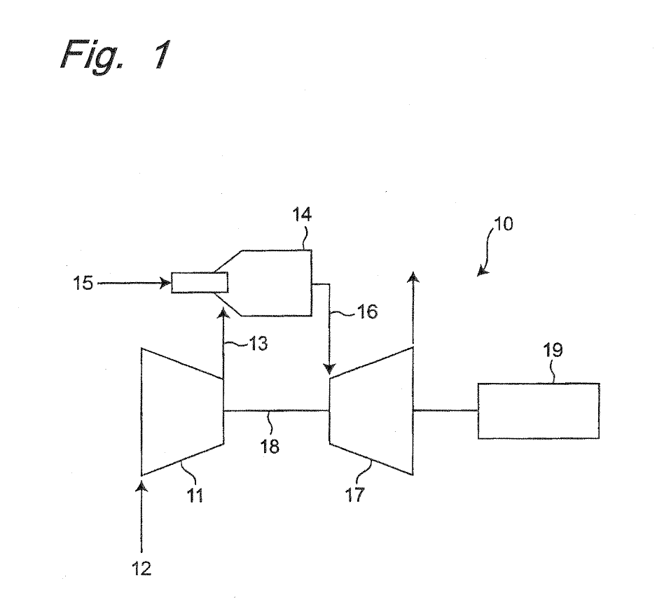

FIG. 1 is a schematic diagram of a general construction and functions of the gas turbine engine (hereinafter simply referred to as an “engine”). Briefly describing the configuration of the engine, generally indicated by reference numeral 10, along with an operation thereof, the engine 10 has a compressor 11 taking in atmospheric air 12 to generate compressed air 13. The compressed air 13 is combusted together with fuel 15 in a combustor 14 to generate high-temperature high-pressure combustion gas 16. The combustion gas 16 is supplied to a turbine 17 where it is used for rotating a rotor 18. The rotation of the rotor 18 is transmitted to the compressor 11 where it is used for generating the compressed air 13. The rotation of the rotor 18 is also transmitted to, for example, a generator 19 where it is used for electric generation.

### First Embodiment

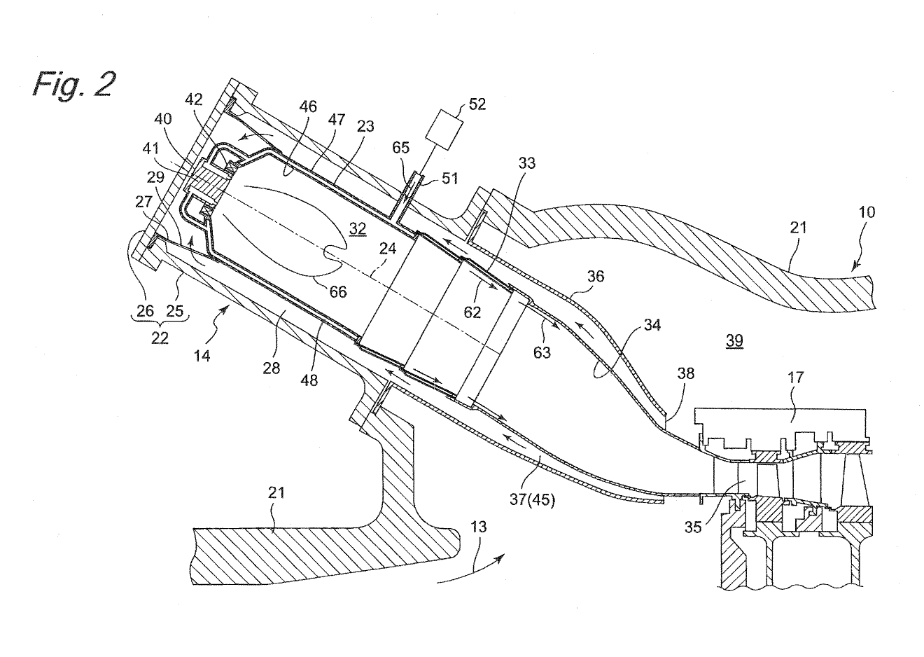

FIG. 2 shows a portion of the engine 10 including the combustor 14.

A plurality of the combustors 14 are disposed at regular intervals around a central axis which is not shown but coincident with a central rotation axis of the rotor 18 of the engine 10 (shown in FIG. 1). Each of the combustors 14 has a cylindrical combustor pressure casing 22 fixed to an outer casing 21 of the engine 10. The combustor pressure casing 22 has a cylindrical combustion liner 23 concentrically disposed inside the combustor pressure casing 22. As shown in FIG. 2, the combustor pressure casing 22 and the combustion liner 23 are fixed to the outer casing 21 to extend obliquely in a direction from the compressor toward turbine such that their central axis 24 intersects with the engine central axis (not shown) at a predetermined angle.

In the embodiment, the combustor pressure casing 22 has a cylindrical portion 25 with one right side end of the cylindrical portion 25 in FIG. 2 coupled to the outer casing 21 and the other left side end of the cylindrical portion 25 in FIG. 2 closed by an end plate 26.

The combustion liner 23 is fixed to the combustor pressure casing 22. In the embodiment, the proximal end portion of the combustion liner 23, indicated on the left side of FIG. 2, is fixed via a support tube 27 to the cylindrical portion 25 of the combustor pressure casing 22 so that a cylindrical space 28 forming a part of a combustion air supply path 45 is defined between the cylindrical portion 25 of the combustor pressure casing 22 and the combustion liner 23. As shown in the drawings, a plurality of apertures 29 forming a part of the combustion air supply path 45 is defined in the support tube 27.

In addition to or in place of the support tube 27, a plurality of connecting members (not shown) may be arranged between the combustor pressure casing 22 and the combustion liner 23 to connect the combustor pressure casing 22 and the combustion liner 23 via the coupling members.

The combustion liner 23 has a combustion chamber 32 formed thereinside. A distal end portion of the combustion liner 23 is concentrically coupled to a cylindrical rear combustor liner 33. A distal end portion of the rear combustor liner 33 is coupled to a cylindrical transition piece 34 with a distal end of the transition piece 34 coupled to a turbine passage 35 of the turbine 17. This allows that the combustion gas generated in the combustion chamber 32 is supplied through the internal spaces of the rear combustor liner 33 and the transition piece 34 into the turbine passage 35 of the turbine 17.

As shown in the drawings, the rear combustor liner 33 and the transition piece 34 are surrounded by a cylindrical cover 36 to define a cylindrical space 37 forming a portion of the combustion air supply path 45 between the rear combustor liner 33 and the transition piece 34 and the cover 36. The cylindrical space 37 communicates with the cylindrical space 28 between the cylindrical portion 25 of the combustor pressure casing and the combustion liner 23. A distal end opening 38 of the cover 36 is opened to a compressed air storage chamber 39 formed inside the outer casing 21. This allows that the compressed air 13 discharged from the compressor 11 moves from the compressed air storage chamber 39 into the cylindrical spaces 37 and then 28.

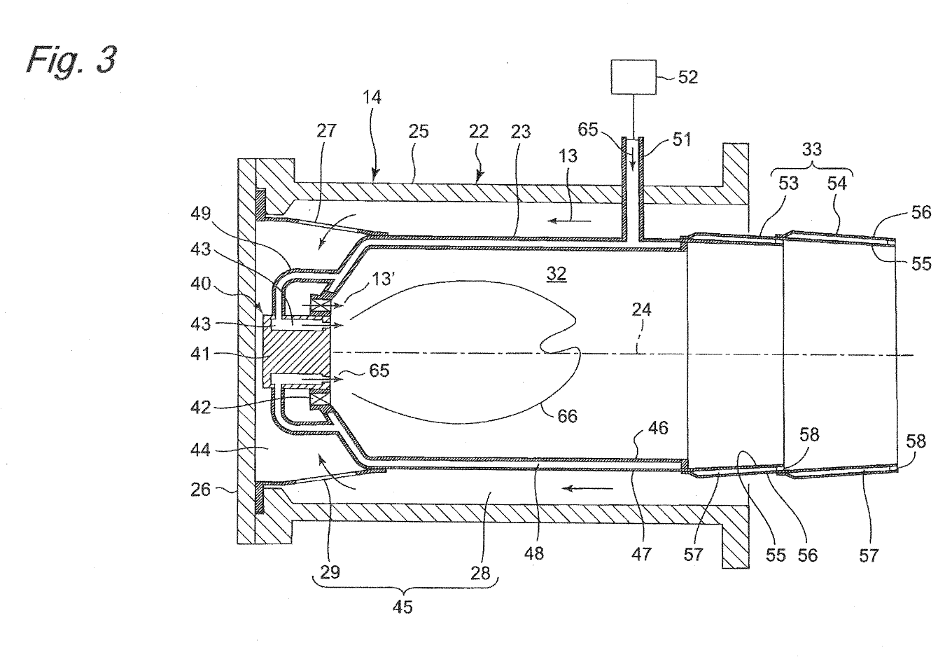

As shown in FIGS. 2 and 3, a proximal end of the combustion liner 23 is coupled to a fuel injector 40. The fuel injector 40 has a fuel injection nozzle 41 for injecting fuel and a combustion air injection nozzle 42 for injecting combustion air. In the embodiment, the fuel injection nozzle 41 is disposed along the central axis 24. In the embodiment, the fuel injection nozzle 41 has a plurality of fuel injection passages 43 formed therein at regular intervals around the central axis 24. In the embodiment, the combustion air injection nozzle 42 is made up of apertures formed around the fuel injection nozzle 41. A space 44, which forms a portion of the combustion air supply path 45 and is defined behind the combustion air injection nozzle 42, is connected through the apertures 29 of the support tube 27 to the cylindrical spaces 28 and 37 around the combustion liner 23, the rear combustor liner 33, and the transition piece 34. This results in that the cylindrical spaces 28 and 37, the support cylinder apertures 29, and the space 44 form the combustion air supply path 45, allowing the compressed air 13 supplied from the compressed air storage chamber 39 to be injected from the combustion air injection nozzle 42 into the combustion chamber 32. Hereinafter, the compressed air 13 injected into the combustion chamber 32 is referred to as “combustion air 13′.”

In the embodiment, the combustion air injection nozzle 42 is made of a swirling vane member or swirler. The swirler includes a number of vanes and, based on a pressure difference between the combustion air supply path 45 including the space 44 therebehind and the combustion chamber 32, applies a swirling force to the combustion air injected from the combustion air supply path 45 into the combustion chamber 32 and thereby to form a swirling flow in the combustion chamber 32.

As shown in detail in FIG. 3, the combustion liner 23 is made up of a cylindrical inner liner 46 and a cylindrical outer liner 47 surrounding the inner liner 46, and a cylindrical space 48 or coolant flow path is formed between the inner liner 46 and the outer liner 47. The cylindrical space 48 is connected at one end thereof indicated on the left side of FIG. 3 through coupling tubes 49 to a plurality of the fuel injection passages 43 formed inside the fuel injection nozzle 41. In the embodiment, the fuel injection passages 43 are formed around the central axis 24. The cylindrical space 48 is connected at the other end thereof indicated on the right side of FIG. 3 through a connecting pipe 51 to a hydrogen supply source 52. As shown in FIG. 3, the proximal end and the distal end of the cylindrical space 48 are closed, so that a hydrogen gas 65 from the hydrogen supply source 52 is supplied through the cylindrical space 48 and the coupling tubes 49 to the fuel injection passages 43 from which hydrogen gas is injected into the combustion chamber 32.

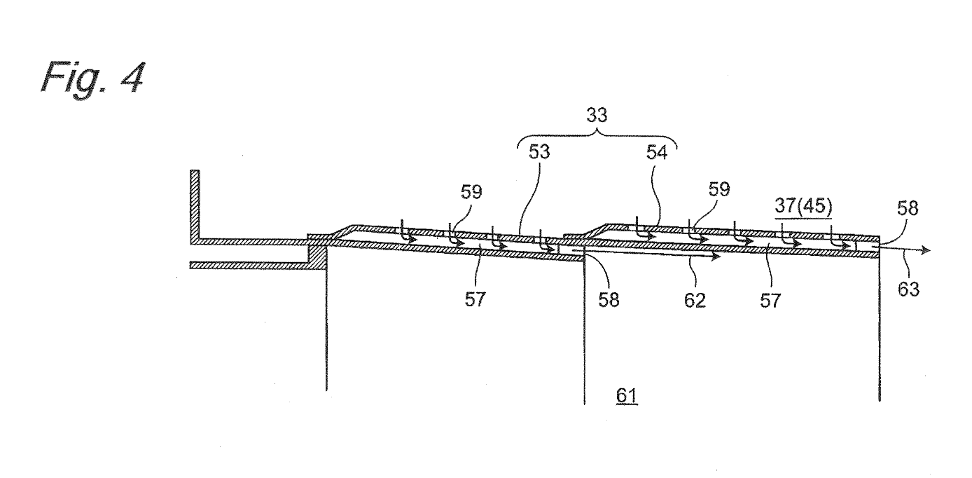

In the embodiment, the rear combustor liner 33 is made up of a proximal end side tailing tube portion 53 and a distal end side tailing tube portion 54. Each of the tailing tube portions 53 and 54 is made up of a cylindrical inner wall 55 and a cylindrical outer wall 56, and an annular cooling space 57 is formed between the inner wall 55 and the outer wall 56. As shown in detail in FIG. 4, the proximal end of the annular cooling space 57 is closed and the distal end of the annular cooling space 57 is opened at an annular outlet 58 which communicates with the inner space of the rear combustor liner 33. A number of apertures 59 are formed in the outer wall 56, which allows that the annular cooling space 57 communicates through the apertures 59 with the combustion air supply path 45.

In the embodiment, the tailing tube portions 53 and 54 are tapered such that an inner diameter gradually decreases from the proximal end to the distal end, and the distal end of the proximal end side tailing tube portion 53 is fitted in the proximal end of the distal end side tailing tube portion 54. Therefore, a portion of the compressed air 13 flowing through the combustion air supply path 45 enters the annular cooling space 57 through the apertures 59 of the outer wall 56 and then impinges the inner wall 55 to cool the inner wall 55. This cooling mechanism is referred to as “impingement cooling.” The air entered in the annular cooling space 57 then moves toward the distal end annular outlet 58 to cool the inner wall 55. This cooling mechanism is referred to as “convection cooling.” Further, the compressed air 13 injected from the distal end annular outlet 58 of the proximal end side tailing tube portion 53 flows along an inner surface of the inner wall 55 of the distal end side tailing tube portion 54 to form a cooling air film 62 inside the inner wall 55. Similarly, the cooling air 13 injected from the distal end annular outlet 58 of the distal end side tailing tube portion 54 flows along an inner surface of the transition piece 34 to form a cooling air film 63 on the inner surface of the transition piece 34.

An operation of the combustor 14 so constructed will be described. In this embodiment, fuel including hydrogen gas 65 and combustion air 13′ are supplied. The hydrogen gas 65 is supplied from the hydrogen supply source 52. The hydrogen gas is a gas composed of preferably 90% or more, more preferably 95% or more, most preferably 99% or more hydrogen (H₂). Hereinafter, each of these gases will be referred to as “pure hydrogen gas”, although it may include inevitably contained impurities. Also, the hydrogen gas may be the one containing hydrogen which is secondarily generated in a manufacturing process in, for example, a chemical factory. Hereinafter, this hydrogen gas will be referred to as “byproduct hydrogen gas”. The same applies to other embodiments. The combustion air 13′ is a high pressure compressed air generated by the compressor 11 as described above and has a temperature of about 400 degrees Celsius to about 500 degrees Celsius. The supplied hydrogen gas 65 has a temperature lower than the high pressure compressed air by 100 degrees or more, preferably a temperature of about 15 to 30 degrees Celsius.

Referring to FIGS. 2 and 3, the hydrogen gas 65 supplied from the hydrogen supply source 52 enters the distal end side of the cylindrical space 48 formed in the combustion liner 23. The hydrogen gas 65 in the cylindrical space 48 cools the inner liner 46 heated by a flame 66 generated in the combustion chamber 32 as described later. Subsequently, the hydrogen gas 65 moves to the proximal end side of the cylindrical space 48 and then enters the fuel injection passages 43 of the fuel injection nozzle 41 through the coupling tubes 49, from which hydrogen gas is injected into the combustion chamber 32. The combustion air 13′, i.e., the compressed air 13, enters the combustion air supply path 45 from the compressed air storage chamber 39 through the distal end opening 38 of the transition piece 34 and passes outside the transition piece 34, the rear combustor liner 33, and the combustion liner 23, from which compressed air is injected through the swirler vanes functioning as the combustion air injection nozzle 42 into the combustion chamber 32 from around the fuel injection nozzle 41.

The hydrogen gas 65 injected into the combustion chamber 32 is combusted in the presence of the combustion air 13′ to form the flame 66. As described above, according to this embodiment, since the inner liner 46 is cooled by the hydrogen gas 65 which is lower in temperature than the compressed air generated by the compressor, the inner liner 46 is effectively cooled than by the compressed air.

The pure hydrogen which is used as fuel contains no or little carbon unlike hydrocarbon-based fuel (e.g., natural gas). Also, a carbon content of the byproduct gas which may be used as fuel is small. Therefore, in either case no adhesion or accumulation of carbide occurs on the inner surface of the combustion liner 23, the rear combustor liner 33, or the transition piece 34, which would otherwise reduce the cooling efficiency.

The high temperature gas 16 generated by the combustion of the fuel is supplied from the rear combustor liner 33 through the transition piece 34 to the turbine passage 35 where it is used for driving the turbine 17.

### Second Embodiment

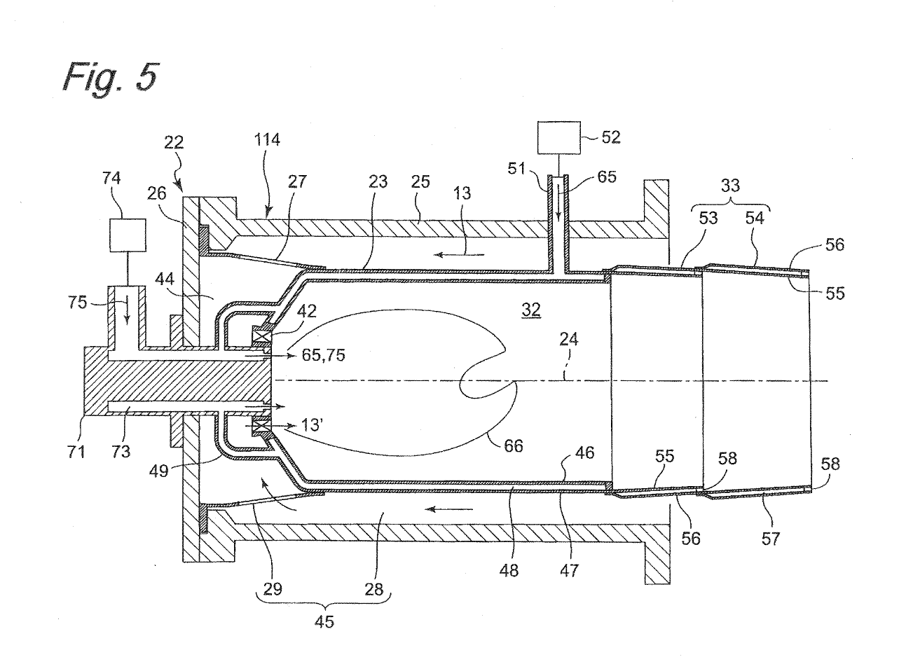

FIG. 5 shows a portion of an engine including a combustor 114 according to a second embodiment. In the drawing, reference numerals used for the first embodiment are used to indicate similar parts of the combustor according to this embodiment.

The combustor 114 of the second embodiment is different from the combustor 14 of the first embodiment in that a fuel containing a water vapor mixed with hydrogen is used. Also, the combustors 114 and 14 have respective fuel injection nozzles with different structures.

Specifically, a fuel injection nozzle 71 of the second embodiment has a plurality of fuel injection passages 73 formed at regular intervals around the central axis 24. The fuel injection passages 73 are connected through the coupling tubes 49 to the cylindrical space 48 of the combustion liner 23 so that the hydrogen gas 65 supplied from the hydrogen supply source 52 is supplied through the cylindrical space 48 and then the connecting pipes 49 to the fuel injection passages 73. The proximal left end side in FIG. 5 of the fuel injection passages 73 is connected to a water vapor supply source 74 (e.g., a boiler), and a water vapor 75 supplied from the water vapor supply source 74 is supplied to the fuel injection passages 73 and is then mixed with the hydrogen gas 65 before being injected into the combustion chamber 32.

According to the combustor 114 so constructed, the hydrogen gas 65 supplied from the hydrogen supply source 52 enters the fuel injection passages 73 from the cylindrical space 48 of the combustion liner 23 through the coupling tubes 49. The water vapor 75 supplied from the water vapor supply source 74 enters the fuel injection passages 73. The hydrogen gas 65 and the water vapor 75 supplied to the fuel injection passages 73 are well mixed with each other in the fuel injection passages 73 and then injected into the combustion chamber 32. The mixture of the hydrogen gas 65 and the water vapor 75 injected into the combustion chamber 32 is combusted together with the combustion air 13′ injected from the surrounding combustion air injection nozzle 42 to form the flame 66.

As described above, in the combustor 114 of the second embodiment, the hydrogen gas 65 absorbs heat when passing through the cylindrical space 48 of the combustion liner 23 and is then mixed in the fuel injection passages 73 with the water vapor 75 supplied to the fuel injection passages 73 before being injected into the combustion chamber 32. The mixture of the hydrogen gas and the water vapor is injected into the combustion chamber 32. This results in that the temperature of the flame is kept lower as compared to that in which the hydrogen gas is not mixed with the water vapor, minimizing the generation of nitrogen oxides which may be contained in the combustion gas.

Also, the hydrogen gas 65 is heated to a certain extent in the cylindrical space 48 and therefore, even if mixed, no condensation of the water vapor 75 occurs in the fuel injector nozzle. This eliminates the risk of corrosion which might be caused due to the adhesion of condensation to the combustion liner. Moreover, the hydrogen containing the desired water vapor can always be injected into the combustion chamber, which results in that the nitrogen oxides contained in the combustion gas can be effectively minimized.

### Third Embodiment

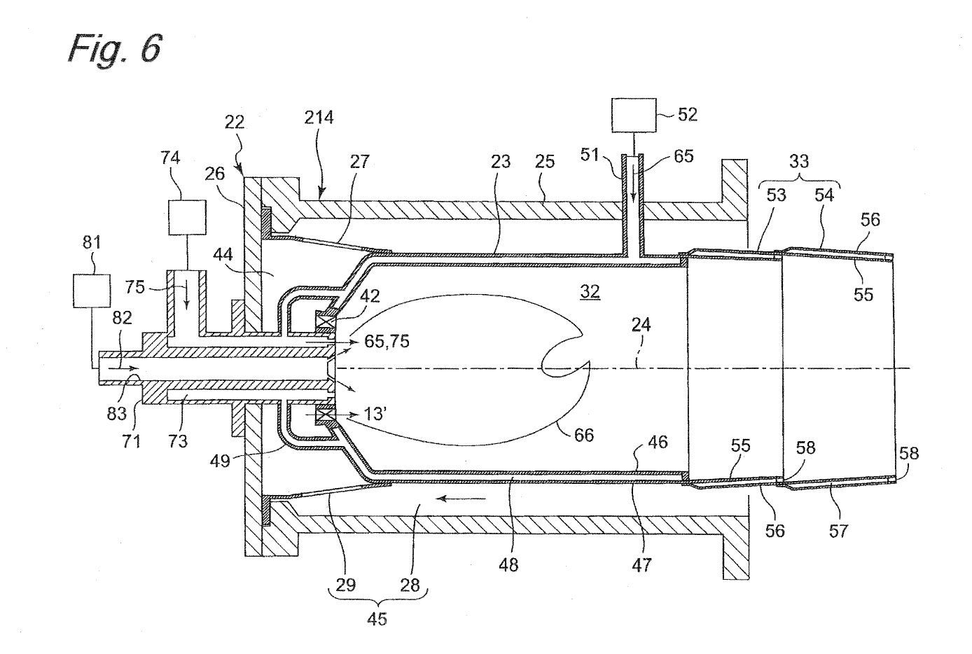

FIG. 6 shows a portion of an engine including a combustor 214 according to a third embodiment. In the drawing, reference numerals used for the combustor 114 according to the second embodiment are used to indicate similar parts of the combustor according to this embodiment.

The combustor 214 of the third embodiment has a fuel supply source 81 for supplying a hydrocarbon such as natural gas. According to the combustor 214, a hydrocarbon 82 supplied from the fuel supply source 81 is injected from a central injection passage 83 of the combustion injection nozzle 71 into the combustion chamber 32 where the hydrocarbon is combusted together with a mixture of the hydrogen gas 65 and the water vapor 75 in the presence of the combustion air 13′ injected from the combustion air injection nozzle 42 to form the flame 66. The fuel supply source 81 may supply not only natural gas but also a mixture of natural gas and hydrogen gas.

### Fourth Embodiment

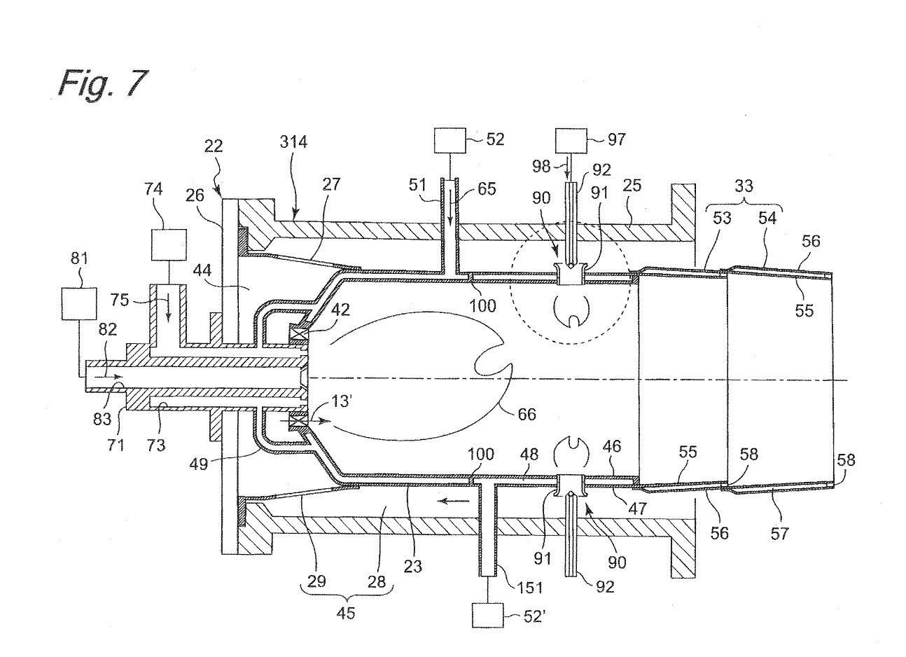

FIG. 7 shows a portion of an engine including a combustor 314 according to a fourth embodiment. In the drawing, reference numerals used for the combustor 214 according to the third embodiment are used to indicate similar parts of the combustor according to this embodiment.

In the combustor 314 of the fourth embodiment, a plurality of supplemental burners 90 are provided on the distal end side of the combustion liner 23. In the embodiment, the supplemental burners 90 are arranged at a predetermined interval in the circumferential direction on a cross section orthogonal to the central axis 24. The supplemental burners 90 have mixing cylinders 91 disposed to extend through the combustion liner 23 in respective radial directions from the center axis 24.

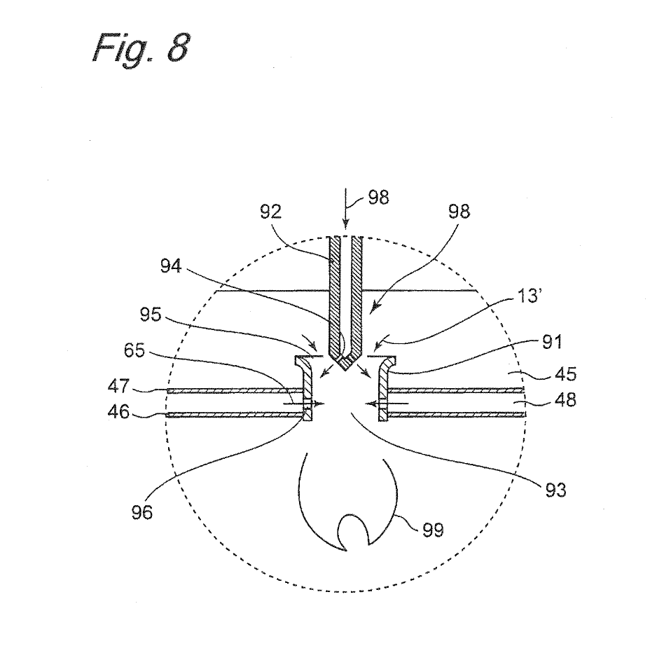

Fuel injection nozzles 92 are fixed to the cylindrical portion 25 of the combustor pressure casing 22 and are arranged so that the central axes of the fuel injection nozzles 92 coincide with the central axes of the mixing cylinders 91. As shown in FIG. 8, a distal end of each of the fuel injection nozzles 92 is positioned within a region, i.e., a mixing chamber 93, surrounded by the mixing cylinder 91 such that a fuel injected from an injection port 94 at the distal end of the fuel injection nozzle 92 is sprayed into the mixing chamber 93.

As shown in the drawing, the inner diameter of the mixing cylinder 91 is larger than the outer diameter of the fuel injection nozzle 92 to form a combustion air introduction port 95 between the mixing cylinder 91 and the fuel injection nozzle 92. A plurality of holes 96 are formed in respective portions of the mixing cylinder 91 positioned in the cylindrical space 48 of the combustion liner 23 to extend through the inner and outer surfaces of the mixing cylinder 91, communicating between the mixing chamber 93 and the cylindrical space 48, which allows that a portion of the hydrogen gas 65 supplied to the cylindrical space 48 is injected into the mixing chamber 93.

In the embodiment, to separate hydrogen gas supplied to the fuel injection nozzle 71 from hydrogen gas supplied to the supplemental burners 90, as shown in FIG. 7, a partition wall 100 is provided in a substantially central portion of the combustion liner 23 such that the hydrogen gas 65 supplied from the hydrogen supply source 52 or a portion thereof is supplied from the connecting pipe 51 to the fuel injection nozzle 71, while the hydrogen gas 65 supplied from a hydrogen supply source (supplemental fuel supply source) 52′ or a portion thereof is supplied from a connecting pipe 151 to the supplemental burners 90. The hydrogen supply source 52′ may be the same as the hydrogen supply source 52.

According to the combustor 314 so constructed, a mixture of the hydrocarbon fuel 82, the water vapor 75, and the hydrogen gas 65 is injected from the fuel injection nozzle 71 and combusted together with the combustion air 13′ injected from the combustion air injection nozzle 42.

In the supplemental burners 90, the fuel 98 supplied from the fuel supply source 97 is injected from the fuel injection nozzles 92 into the mixing chamber 93. In the mixing chamber 93, the hydrogen gas 65 supplied from the hydrogen supply source 52′ enters the cylindrical space 48 and then passes through the holes 96 of the mixing cylinders 91 into the mixing chambers 93, and a portion of the compressed air 13 flowing through the combustion air supply path 45 is supplied as the combustion air 13′ to the mixing chambers 93 where the fuel 98, the hydrogen gas 65, and the combustion air 13′ are mixed with each other. The mixture is then injected into the combustion chamber 32 and then combusted to form a flame 99.

Therefore, according to the combustors of the third and fourth embodiments, the same advantages as those of the combustors of the first and second embodiments are obtained.

In the above description, the combustion liner 23 is formed of the inner liner 46 and the outer liner 47 to form therebetween the cylindrical space for supplying hydrogen gas; however, the space formed around the inner liner 46 may not be a cylindrical space which extends continuously in the circumferential direction, and the space for hydrogen gas supply may be formed in a manner, other than a double tube structure made of inner and outer liners, that a number of tubes are arranged around the inner liner.

### PARTS LIST

10: gas turbine engine
11: compressor
12: air
13: compressed air
14: combustor
15: fuel
16: combustion gas
17: turbine
18: rotor
19: generator
21: outer casing
22: pressure casing
23: combustion liner
24: central axis (central axis of a combustor pressure casing and a combustion liner)
25: cylindrical portion
26: end plate
27: support tube
28: cylindrical space (portion of a combustion air supply path)
29: aperture of a support tube (portion of a combustion air supply path)
32: combustion chamber
33: rear combustor liner
34: transition piece
35: turbine passage
36: cover
37: cylindrical space (portion of a combustion air supply path)
38: distal end opening
39: compressed air storage chamber
40: combustion injector
41: fuel injection nozzle
42: combustion air injection nozzle
43: fuel injection passage
44: space
45: combustion air supply path
46: inner liner
47: outer liner
48: cylindrical space (coolant flow path)
49: coupling tube
51: connecting pipe
52: hydrogen supply source
53: proximal end side tailing tube portion
54: distal end side tailing tube portion
55: inner wall
56: outer wall
57: annular cooling space
58: annular exit
59: aperture
62: cooling air film
63: cooling air film
65: hydrogen gas
66: flame

1. A combustor for a gas turbine comprising:
a combustion liner; and
a fuel injector provided at one end of the combustion liner to extend through the combustion liner,
the combustion liner further comprising
an inner liner forming a combustion chamber therein,
a coolant flow path in a cylindrical space formed outside the inner liner, and
a coolant supply configured to supply a hydrogen gas to the coolant flow path.

2. The combustor according to claim 1,
wherein the coolant flow path is connected to the fuel injector, and
wherein a hydrogen gas supplied from the coolant supply through the coolant flow path to the fuel injector is injected from the fuel injector into the combustion chamber.

3. The combustor according to claim 2,
wherein the fuel injector is connected to a water vapor supply source, and
wherein a water vapor supplied from the water vapor supply source and the hydrogen supplied from the hydrogen supply source are mixed in the fuel injector and then injected into the combustion chamber.

4. The combustor according to claim 3,
wherein the fuel injector is connected to a hydrocarbon fuel supply source, and
wherein the hydrocarbon fuel injected from the fuel injector into the combustion chamber is combusted together with the hydrogen and the water vapor in the combustion chamber.

5. The combustor according to claim 1,
wherein the combustion liner includes at least one supplemental burner, and
wherein the supplemental burner has a supplemental fuel supply source.

6. The combustor according to claim 5, wherein the supplemental fuel supply source is a hydrogen supply source.

7. A gas turbine engine comprising the combustor according to claim 1.

8. A gas turbine engine comprising the combustor according to claim 2.

9. A gas turbine engine comprising the combustor according to claim 3.

10. A gas turbine engine comprising the combustor according to claim 4.

11. A gas turbine engine comprising the combustor according to claim 5.

12. A gas turbine engine comprising the combustor according to claim 6.
